(19) United States
(12) Patent Application Publication
(10) Pub. No.: US 2023/0065319 A1
(43) Pub. Date: Mar. 2, 2023

(54) WOODWORKING PLANE STAND

(71) Applicants: Darrell Chapnick, North Haven, CT (US); Benjamin Russell Beattie-Chapnick, Milford, CT (US)

(72) Inventors: Darrell Chapnick, North Haven, CT (US); Benjamin Russell Beattie-Chapnick, Milford, CT (US)

(21) Appl. No.: 17/460,459

(22) Filed: Aug. 30, 2021

(51) Int. Cl. A47F 7/00; A47F 5/10

(52) U.S. Cl. CPC A47F 7/0042; A47F 5/108; B27G 17/02

(57) ABSTRACT

A woodworking plane stand, the woodworking plane stand comprising: a back member; a left leg removeably attachable to the back member via a sliding dovetail joint; a right leg removably attachable to the back member via a sliding dovetail joint; the left leg comprising a left first step and an angled stop member located on a distal end of the left first step, the angled stop member making an acute angle with the inner side of the left leg; the right leg comprising a right first step and an angled stop member located on a distal end of the right first step, the angled stop member making an acute angle with the inner side of the right leg; the left first step and right first step configured to be at the same height when the left leg and right leg are attached to the back member; the left first step and right first step configured to support and display a woodworking plane, and the angle stop members configured to prevent the woodworking plane from sliding off the distal end of the left first step and right first step.

### TECHNICAL FIELD

The present invention relates generally to a woodworking plane stand, and more particularly, to a woodworking plane stand comprising three pieces.

### BACKGROUND

With millions of woodworking planes having already been manufactured, many collectors as well as craftsmen including but not limited to carpenters, woodworkers, makers, etc., desire to display their woodworking planes. Currently, there are no known woodworking plane stands on the market. Further, off the shelf stands for knickknacks, and other collectables, are generally not strong enough or sized correctly to hold and display several woodworking planes, which can weigh more than 5 pounds each.

Thus there is a need for a woodworking plane stand that overcomes the above listed and other disadvantages.

### SUMMARY OF THE INVENTION

The disclosed invention relates to a woodworking plane stand, the woodworking plane stand comprising: a back member; a left leg removeably attachable to the back member via a sliding dovetail joint; a right leg removably attachable to the back member via a sliding dovetail joint; the left leg comprising a left first step and an angled stop member located on a distal end of the left first step, the angled stop member making an acute angle with the inner side of the left leg; the right leg comprising a right first step and an angled stop member located on a distal end of the right first step, the angled stop member making an acute angle with the inner side of the right leg; the left first step and right first step configured to be at the same height when the left leg and right leg are attached to the back member; the left first step and right first step configured to support and display a woodworking plane, and the angle stop members configured to prevent the woodworking plane from sliding off the distal end of the left first step and right first step.

### BRIEF DESCRIPTION OF THE DRAWINGS

The present disclosure will be better understood by those skilled in the pertinent art by referencing the accompanying drawings, where like elements are numbered alike in the several figures, in which:

FIG. 1 is a front view of the disclosed woodworking plane stand;

FIG. 2 is a side view of the disclosed woodworking plane stand;

FIG. 3 is a front view of the back member, left leg and right leg of the disclosed woodworking plane stand;

FIG. 4 is a back view of the disclosed woodworking plane stand;

FIG. 5 is a front view of another embodiment of the disclosed woodworking plane stand;

FIG. 6 is a side perspective view of the disclosed woodworking plane stand from FIG. 5;

FIG. 7 is a close up view of the first steps of the left leg and right leg;

FIG. 8 is a rear view of the disclosed woodworking plane stand from FIG. 5;

FIG. 9 is a close up view of the right leg dovetail and dovetail socket;

FIG. 10 is a close up view of the right leg dovetail and dovetail socket from below;

FIG. 11 is a close up view of the right leg dovetail inside the dovetail socket;

FIG. 12 is a rear from of the back member;

FIG. 13 is a close up rear view of the dovetail socket;

FIG. 14 is a perspective view of one embodiment of the left leg;

FIG. 15 is a perspective view of another embodiment of the left leg;

FIG. 16 is a close up view of the inner side of the left leg from FIG. 14;

FIG. 17 is a close up view of the inner side of the left leg from FIG. 15;

FIG. 18 is a front view of the disclosed woodworking plane stand holding four woodworking planes; and

FIG. 19 is a close up view of two woodworking planes being displayed on the disclosed woodworking plane stand.

### DETAILED DESCRIPTION OF THE INVENTION

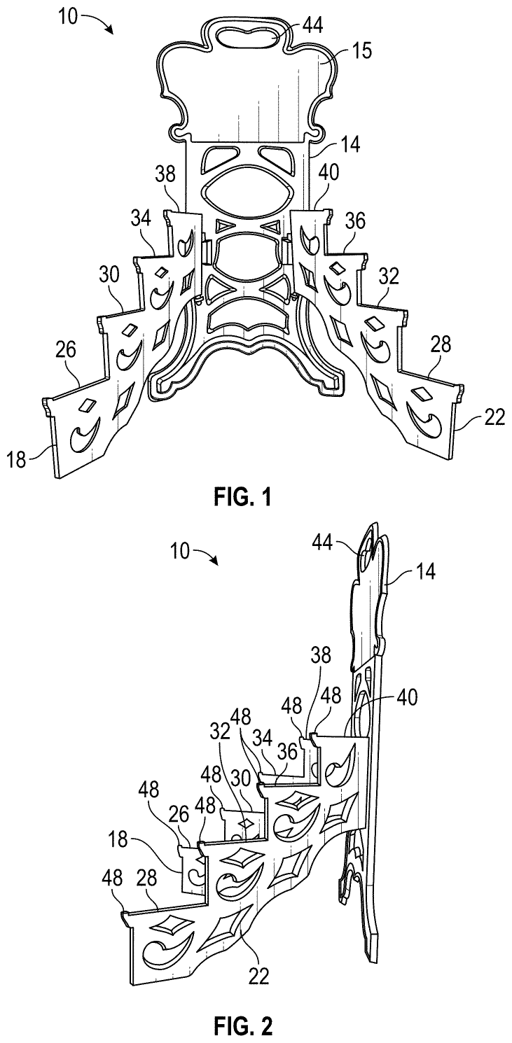

FIG. 1 is a front view of the disclosed woodworking plane stand 10. The stand comprises a back member 14, a left leg 18, and a right leg 22. Each leg has a plurality of horizontal steps, with a pair of steps—one from each leg, at the same height. In this embodiment, left leg 18 has a first step 26, second step 30, third step 34, and fourth step 38. Similarly, the right leg has a first step 28, second step 32, third step 36, and fourth step 40. The first pair of steps, 26, 28 are at the same height, the second pair of steps 30, 32 are at the same height, the third pair of steps 34, 36 are at the same height, and the fourth pair of steps 38, 40 are at the same height. The back member 14 may have an opening 44 for a handhold or fingerhold. When the woodworking plane stand 10 is assembled as shown in FIG. 1, then it can hold up to 4 woodworking planes, with one plane sitting on each pair of steps. The back member may comprise a messaging area 15. The messaging area may have the name or logo of the manufacturer of the woodworking planes being displayed or words that described features of the plane, such as Stanley or Adjustable. In addition, the user may request any word or design to be displayed in the messaging area 15—and the manufacture can produce a back member 14 with such a word or design.

FIG. 2 shows a side view of the stand 10. In this view, each step 26, 28, 30, 32, 34, 36, 38, and 40 are shown with a stop member 48 extending upward from each respective step. The stop members 48 are configured to prevent a woodworking plane from sliding off the pair of steps the plane is resting on.

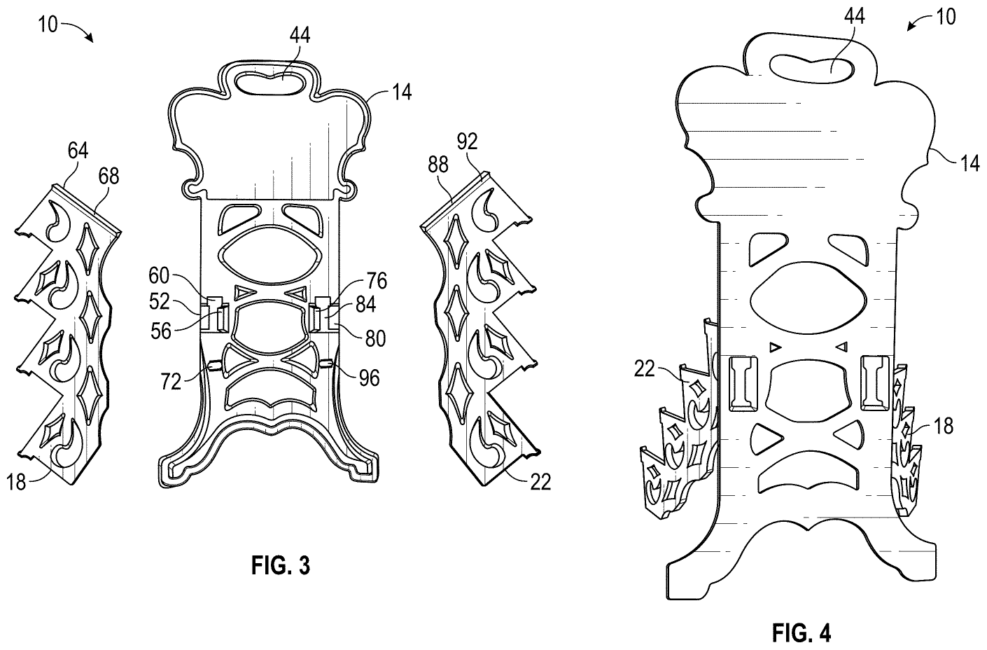

FIG. 3 is a front view of a disassembled stand 10. The left leg 18 may be attached to the back member 14 via a sliding dovetail joint. A first dovetail socket member 52, a second dovetail socket member 56 form a left leg dovetail socket 60. The left leg 18 has a dovetail 64 on its attachment end 68. In addition, there is a left leg dovetail stop member 72 on the back member, below the dovetail socket 60. The dovetail 64 slides down into the dovetail socket 60 until it is stopped when the dovetail 60 abuts the dovetail stop member 72. Similarly, a third dovetail socket member 76, a fourth dovetail socket member 80 form a right leg dovetail socket 84. The right leg 22 has a dovetail 88 on its attachment end 92. In addition, there is a right leg dovetail stop member 96 on the back member, below the right leg dovetail socket 84. The dovetail 88 slides down into the dovetail socket 84 until it is stopped when the dovetail 88 abuts the dovetail stop member 96.

FIG. 4 is a rear view of the assembled woodworking plane stand 10.

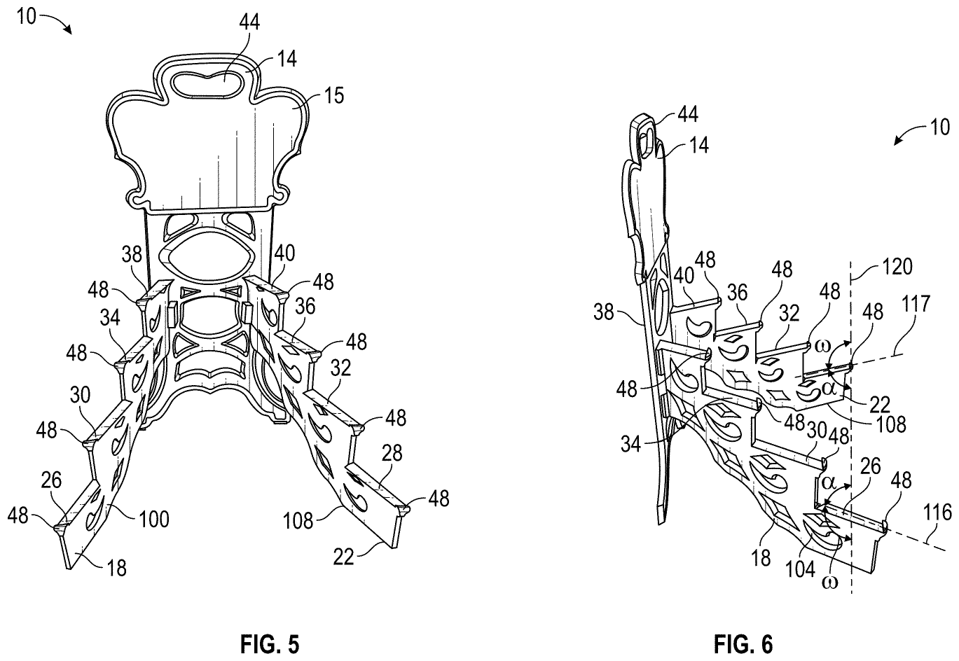

FIG. 5 is a front view of another embodiment of a woodworking plane stand 10.

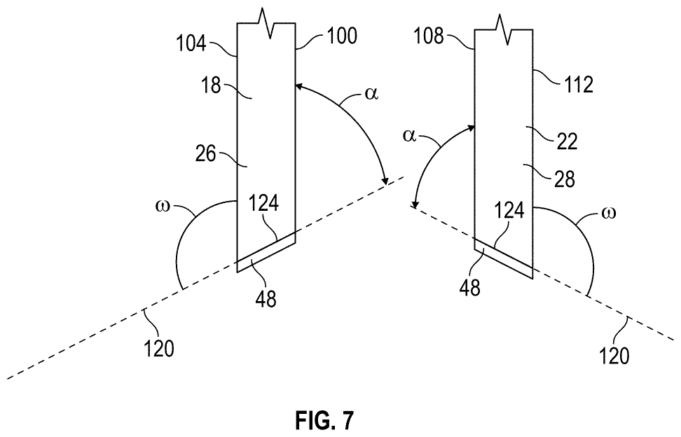

FIG. 6 is a side perspective view of the woodworking plane stand 10 from FIG. 5. In this view, one can see that the stop members 48 are angled with respect to the legs 18, 22 such that when the legs are installed into the back member, the stop members are generally parallel to the back member. Thus, in one embodiment, the stop members 48 are at an acute angle α with the inner side 100 (see FIG. 5) of the left leg 18, and at an obtuse angle ω with the outer side 104 of the left leg 18. Line 120 represents an imaginary line along the inner surface of the stop member 48. Similarly, the stop members 48 are at an acute angle α with the inner side 108 of the right leg 22, and at an obtuse angle ω with the outer side 112 (see FIG. 7) of the right leg 22.

FIG. 7 is a close up top view of a portion of the left leg 18 and top leg 22. In this view, the acute angle α between the inner surface 124 of the stop member 48 and the inner surface 100 of the left leg is clearly seen. Similarly, the obtuse angel w between the inner surface 124 of the stop members and the outer surface of the left leg is also clearly seen. The legs 18, and 22 are not installed in the back member 14 in this view.

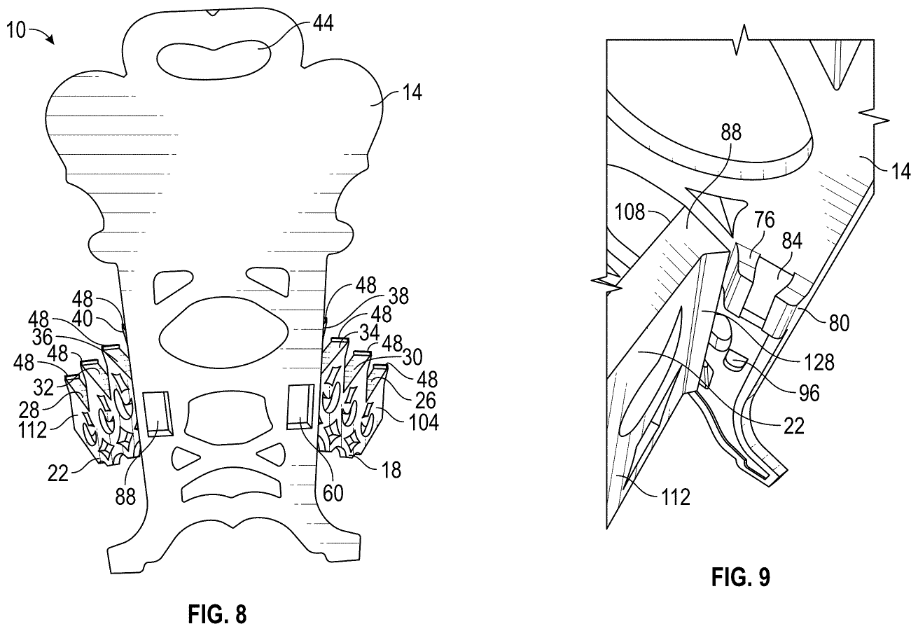

FIG. 8 is a rear view of the stand from FIG. 5.

FIG. 9 is a close up view of the dovetail 88 and right leg dovetail socket 84. In this embodiment, one can see that the inner side 108 of the right leg 22 has a generally planar shape, even at the portion of the dovetail 88. However, on the outer side 112 of the right leg 22, the dovetail 88 comprises a triangular shape 128 that extends down the height of the right leg 22. The outer side 112 has a generally planar shape, except for the portion of the triangular shape that extends out from the planar shape of the outer side 112. Also note the right leg dovetail stop member 96.

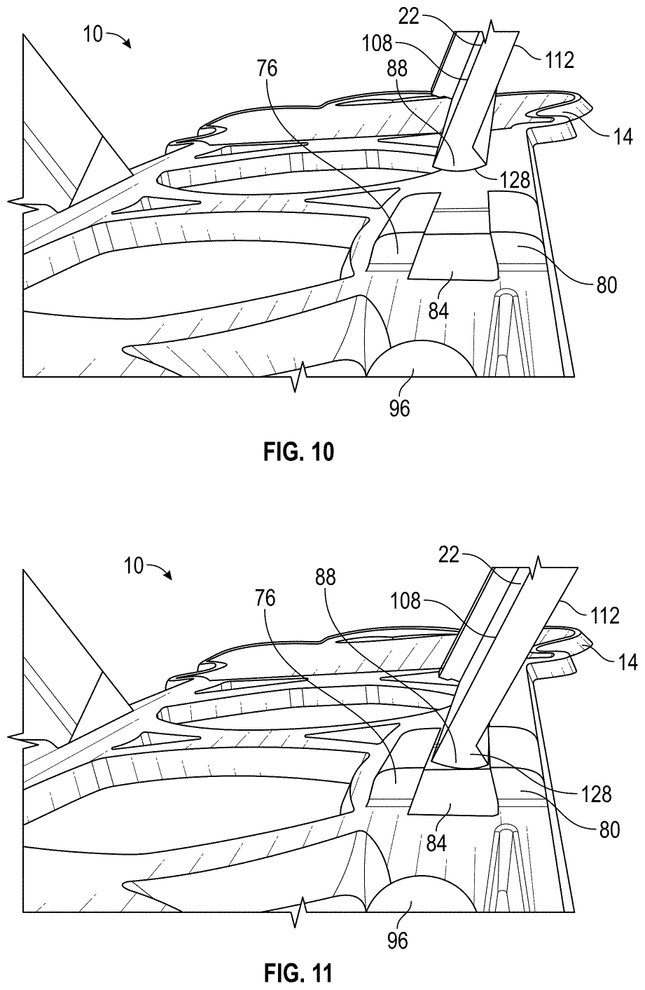

FIG. 10 is a close up view of the bottom of the right leg dovetail socket 84 looking up towards the top of the back member 14. The right leg dovetail 88 is shown near the right leg dovetail socket 84.

FIG. 11 is a view of the right leg dovetail 88 inserted into the right leg dovetail socket 84.

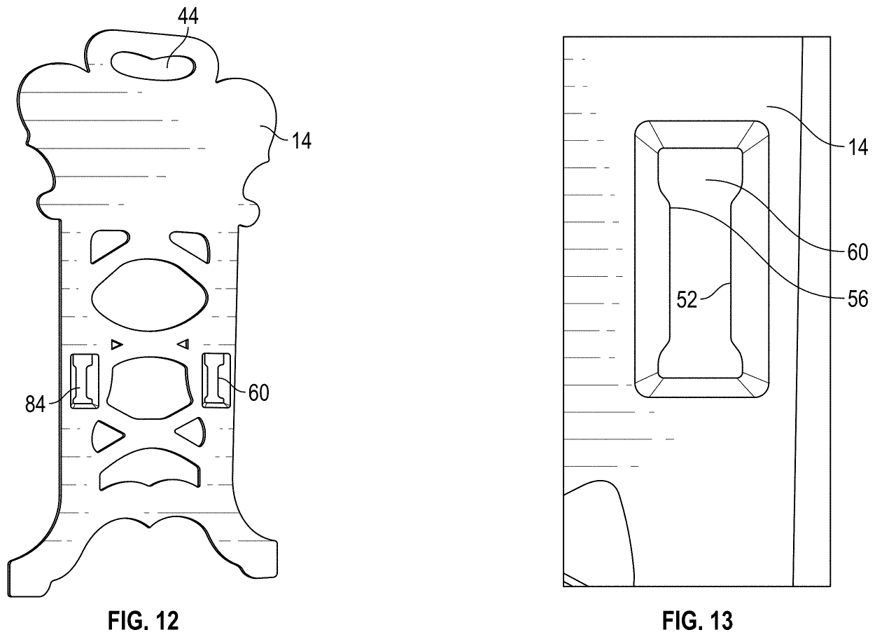

FIG. 12 is a rear view of the back member 14.

FIG. 13 is a close up rear view of the left leg dovetail socket 60.

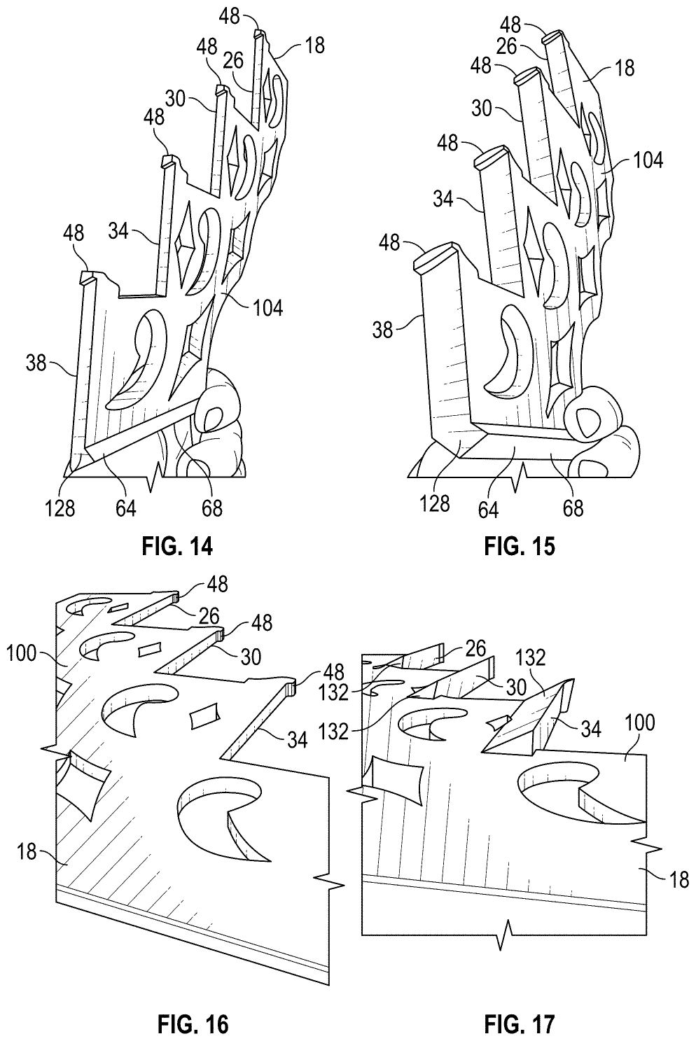

FIG. 14 shows one embodiment of the left leg 18. In this view, the outer side 104 is visible.

FIG. 15 shows another embodiment of the left leg 18. In this view, the outer side 104 is visible. Note how the steps 26, 30, 34, 38 are wider in this embodiment, than in the embodiment shown in FIG. 14. Also, the dovetail 64 is also larger in the embodiment of FIG. 15, than in the embodiment in FIG. 14.

FIG. 16 shows a close up view of the inner side 100 of the embodiment from FIG. 14 of the left leg 18.

FIG. 17 shows a close up view of the inner side 100 of the embodiment from FIG. 15 of the left leg 18. In this view, the wider steps 26, 30, 34, 38, are shown to be built up by a triangular shape buildup 132 on the inner side 100.

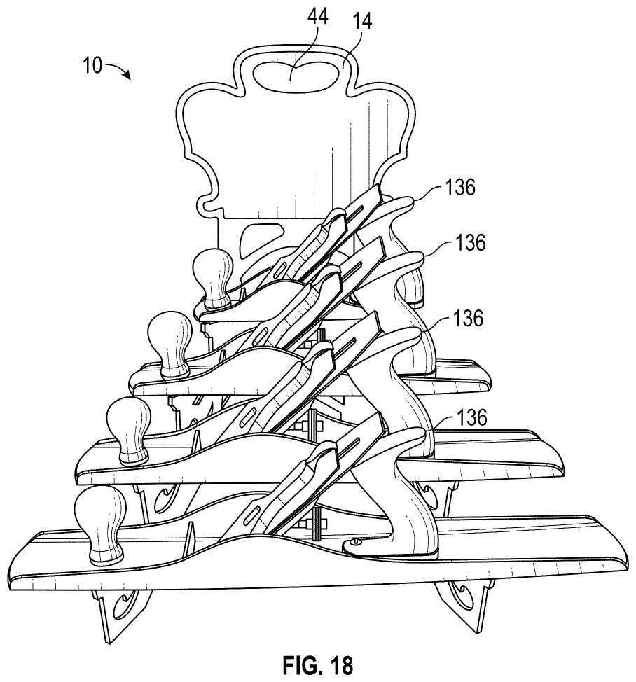

FIG. 18 shows a front view of the woodworking plane stand 10 with 4 woodworking planes 136 displayed on the stand 10.

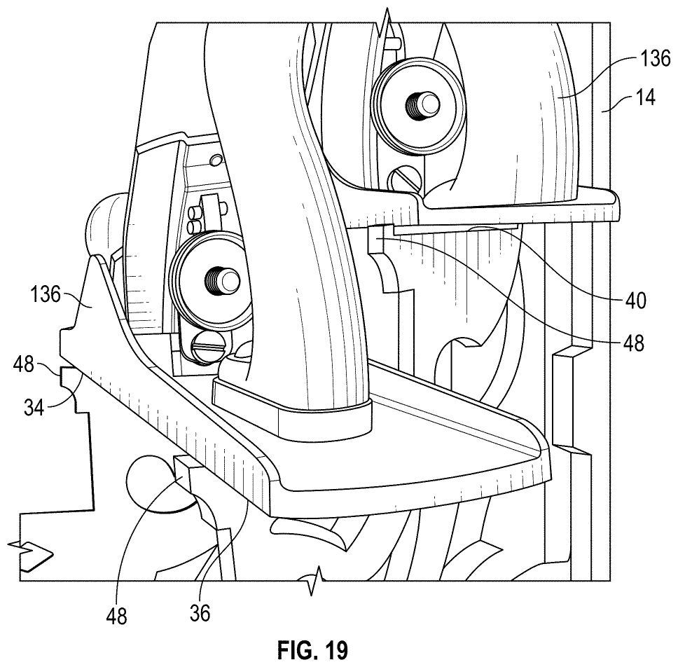

FIG. 19 shows a perspective side close up view of the stand 10 from FIG. 18. In this view the pair of steps, 34, 36 has a woodworking plane 136 sitting on the steps 34, 36. Also, the pair of steps 38, and 40 has a woodworking plane 136 sitting on the steps 38, 40. In this view, the stop members 48 are shown abutting the woodworking planes 136, generally keeping the planes 136 on their respective steps.

The disclosed stand has been shown with four pairs of steps, and configured to hold up to 4 woodworking planes. However, one of ordinary skill will recognize that the stand can be modified to hold fewer or more woodworking planes. In one example, the stand may have one pair of steps to hold 1 wood working plane, in another example, the stand may have 2 pairs of steps to hold 2 woodworking planes. In still another example, the stand may 3 pairs of steps, 5 pair of steps, etc.

The back member, left leg and right leg may be sand casted in metal, sprues and flashing may then be cut away. The stand's edges may then be sanded and then the whole stand may be painted in enamel based paint. Then a contrasting paint may be inset into the back member's logo design area. The left and right legs may then be lifted and dropped into the dovetail socket on the front of the back member. Lastly, the woodworking planes may be placed on a pair of steps on the stand.

The disclosed woodworking plane stand has many advantages. The stand is sturdy and easy to assemble. The stand comprises only 3 pieces, the back member, left leg and right leg. Limiting the stand to 3 pieces will result in lower manufacturing costs. The stand is configured expressly for the display of woodworking planes. The stand and woodworking planes can be carried about the handhold or fingerhold. Using a simple 3-piece design cast out of metal (Aluminum/Bronze/Cast Iron) provides for a strong stand and minimum complexity. The stand has two legs (left and right side). The stand requires no fasteners, hinges, and/or axels—which vastly simplifies the stand. The legs drop down and lock into a dovetail receptacle. The legs may stop in the dovetail socket via friction fit or via a dovetail stop member on the front of the back member. Another advantage of the stand is that the design cannot fail due to loose fasteners or hinge failures etc. making it extremely reliable and strong. Additionally, due to gravity, the legs become increasingly secure as more woodworking planes are added to the stand. Thus the increased weight will create a joint increasing the overall rigidity of the stand. Another feature of the stand is its ability to store and organize different size woodworking planes safely on the pairs of steps. The steps are designed into the legs to provide the ability to place smaller woodworking planes towards the top steps and thus woodworking planes of increasing size/length on each lower pair of steps. A stop member or small hook is designed into the step to prevent the woodworking plane from sliding off thereby providing a secure means of a organized storage display. The messaging portion of the back member can display a logo, text, or other design. This gives the user the ability customize his or her stand.

It should be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims.

What is claimed is:

1. A woodworking plane stand, the woodworking plane stand comprising:
a back member;
a left leg removeably attachable to the back member via a sliding dovetail joint;
a right leg removably attachable to the back member via a sliding dovetail joint;
the left leg comprising a left first step and an angled stop member located on a distal end of the left first step, the angled stop member making an acute angle with the inner side of the left leg;
the right leg comprising a right first step and an angled stop member located on a distal end of the right first step, the angled stop member making an acute angle with the inner side of the right leg;
the left first step and right first step configured to be at the same height when the left leg and right leg are attached to the back member;
the left first step and right first step configured to support and display a woodworking plane, and the angle stop members configured to prevent the woodworking plane from sliding off the distal end of the left first step and right first step.

2. The woodworking plane stand of claim 1, wherein the angled stop members are generally parallel to the back member when the stand is assembled.

3. The woodworking plane stand of claim 1, further comprising:
a left leg dovetail located on a left leg attachment end, the inside surface of the left leg adjacent to the dovetail defining a generally planar surface, the left leg dovetail forming a triangular shape that extends out from the outside surface of the left leg and the triangular shape also extends down the height of the left leg;
a right leg dovetail located on a right leg attachment end, the inside surface of the right leg adjacent to the dovetail defining a generally planar surface, the right leg dovetail forming a triangular shape that extends out from the outside surface of the right leg and the triangular shape also extends down the height of the right leg.

4. The woodworking plane stand of claim 1, further comprising:
a first left leg socket member extending out from the front of the back member;
a second left leg socket member extending out from the front of the back member, the second left leg socket member parallel to the first left leg socket member;
the first left leg socket member and second left leg socket member forming a left leg dovetail socket, the left leg dovetail socket configured to accept a left leg dovetail located on the attachment end of the left leg;
a left leg dovetail stop member located adjacent and below the left leg dovetail socket, the left leg dovetail stop member configured to stop the left leg dovetail from sliding past the left leg dovetail stop member;
a first right leg socket member extending out from the front of the back member;
a second right leg socket member extending out from the front of the back member, the second right leg socket member parallel to the first right leg socket member;
the first right leg socket member and second right leg socket member forming a right leg dovetail socket, the right leg dovetail socket configured to accept a right leg dovetail located on the attachment end of the right leg; and
a right leg dovetail stop member located adjacent and below the right leg dovetail socket, the right leg dovetail stop member configured to stop the right leg dovetail from sliding past the right leg dovetail stop member.

5. The woodworking plane stand of claim 1, further comprising:
a left second step located on the left leg with an angled stop member located on a distal end of the left second step, the angled stop member making an acute angle with the inner side of the left leg, the left second step at a higher elevation than the left first step when the stand is assembled and the left second step angled stop member generally parallel to the back member when the stand is assembled;
a right second step located on the right leg with an angled stop member located on a distal end of the right second step, the angled stop member making an acute angle with the inner side of the right leg, the right second step at a higher elevation than the right first step when the stand is assembled, and the right second step at the same elevation as the left second step when the stand is assembled, and the right second step angled stop member generally parallel to the back member when the stand is assembled.

6. The woodworking plane stand of claim 5, further comprising:
a left third step located on the left leg with an angled stop member located on a distal end of the left third step, the angled stop member making an acute angle with the inner side of the left leg, the left third step at a higher elevation than the left second step when the stand is assembled and the left third step angled stop member generally parallel to the back member when the stand is assembled;
a right third step located on the right leg with an angled stop member located on a distal end of the right third step, the angled stop member making an acute angle with the inner side of the right leg, the right third step at a higher elevation than the right second step when the stand is assembled, and the right third step at the same elevation as the left third step when the stand is assembled, and the right third step angled stop member generally parallel to the back member when the stand is assembled.

7. The woodworking plane stand of claim 6, further comprising:
a left fourth step located on the left leg with an angled stop member located on a distal end of the left fourth step, the angled stop member making an acute angle with the inner side of the left leg, the left fourth step at a higher elevation than the left third step when the stand is assembled and the left fourth step angled stop member generally parallel to the back member when the stand is assembled;
a right fourth step located on the right leg with an angled stop member located on a distal end of the right fourth step, the angled stop member making an acute angle with the inner side of the right leg, the right fourth step at a higher elevation than the right third step when the stand is assembled, and the right fourth step at the same elevation as the left fourth step when the stand is assembled, and the right fourth step angled stop member generally parallel to the back member when the stand is assembled.

8. The woodworking plane stand of claim 1, further comprising:
an opening near the top of the back member configured for a handhold or fingerhold.

9. The woodworking plane stand of claim 1, wherein the back member, left leg, and right leg are made from cast iron.

10. The woodworking plane stand of claim 1, wherein the back member, left leg, and right leg are sand casted in metal.

11. The woodworking plane stand of claim 1, wherein the back member, left leg, and right leg are casted in bronze.

12. The woodworking plane stand of claim 1, wherein the back member, left leg, and right leg are casted in aluminum.
